(19) United States
(12) Patent Application Publication
(10) Pub. No.: US 2006/0280673 A1
(43) Pub. Date: Dec. 14, 2006

(54) Processes for producing an aqueous solution containing chlorine dioxide

(76) Inventor: Felice DiMascio, Rocky Hill, CT (US)

Correspondence Address: CANTOR COLBURN, LLP, 55 GRIFFIN ROAD SOUTH, BLOOMFIELD, CT, 06002, US

(21) Appl. No.: 11/451,208

(22) Filed: Jun. 12, 2006

Related U.S. Application Data
(60) Provisional application No. 60/689,600, filed on Jun. 10, 2005.

(51) Int. Cl. B01J 21/00

(52) U.S. Cl. 423/477; 502/240

(57) ABSTRACT

A process for producing chlorine dioxide comprises flowing an aqueous acidified chlorite salt solution of into a catalyst element, wherein the catalyst element comprises an aluminosilicate hydrogel-bonded porous ceramic support defining a plurality of tortuous pathways and catalyst particles and/or catalytic sites disposed on surfaces defining the tortuous pathways; and contacting the aqueous solution of chlorous acid with the catalyst particles and/or catalytic sites to form chlorine dioxide in the aqueous solution.

### CROSS REFERENCE TO RELATED APPLICATIONS

The present application claims the benefit of U.S. Provisional Application No. 60/689,600 filed on Jun. 10, 2005, the contents of which are incorporated by reference in its entirety.

### BACKGROUND

This disclosure generally relates to a process for producing an aqueous solution containing chlorine dioxide.

With the decline of gaseous chlorine as a microbiocide, various alternatives have been explored, including bleach, bleach with bromide, bromo-chlorodimethyl hydantoin, ozone, and chlorine dioxide (ClO₂). Of these, chlorine dioxide has generated a great deal of interest for control of microbiological growth in a number of different industries, including the dairy industry, the beverage industry, the pulp and paper industries, the fruit and vegetable processing industries, various canning plants, the poultry industry, the beef processing industry and miscellaneous other food processing applications. Chlorine dioxide is also seeing increased use in municipal potable water treatment facilities and in industrial waste treatment facilities, because of its selectivity towards specific environmentally-objectionable waste materials, including phenols, sulfides, cyanides, thiosulfates, and mercaptans. In addition, chlorine dioxide is being used in the oil and gas industry for downhole applications as a well stimulation enhancement additive.

Unlike chlorine, chlorine dioxide remains a gas when dissolved in aqueous solutions and does not ionize to form weak acids. This property is at least partly responsible for the biocidal effectiveness of chlorine dioxide over a wide pH range, and makes it a logical choice for systems that operate at alkaline pH or that have poor pH control. Moreover, chlorine dioxide is a highly effective microbiocide at concentrations as low as 0.1 parts per million (ppm) over a wide pH range.

The biocidal activity of chlorine dioxide is believed to be due to its ability to penetrate bacterial cell walls and react with essential amino acids within the cell cytoplasm to disrupt cell metabolism. This mechanism is more efficient than other oxidizers that “burn” on contact and is highly effective against legionella pneumophilia, algae and amoebal cysts, giardia cysts, coliforms, salmonella, shigella, various viruses, and cryptosporidium.

Unfortunately, chlorine dioxide in solution is unstable with an extremely short shelf life and thus, is not commercially available. Chlorine dioxide must typically be generated at its point of use such as, for example, by a reaction between an aqueous solution of a metal chlorate salt or metal chlorite salt and a strong acid. To increase the yield, it oftentimes desirable to employ a catalyst.

Catalysts, which may generally take the form of heterogeneous, homogeneous, or biological catalysts, are of significant importance to the chemical industry as evidenced by the fact that the great majority of all chemicals produced have been in contact with a catalyst at some point during their production. Despite the many advances in the areas of homogeneous and biological catalysis, heterogeneous catalysts remain the predominant form used by industry. Heterogeneous catalysts are favored in part because they tolerate a much wider range of reaction temperatures and pressures, they can be more easily and inexpensively separated from a reaction mixture by filtration or centrifugation, they can be regenerated, and they are less toxic than their homogeneous or biological counterparts.

Heterogeneous catalysts utilized in chlorine dioxide generation processes are generally a granular solid material that operates on reactions taking place in the gaseous or liquid state, and generally includes a reactive species and a support for the reactive species. One problem associated with granular heterogeneous catalysts is catalyst attrition through the release of catalyst fines, which are small particles of spent catalyst that can remain in the reaction mixture and/or pass into the products. The generation of catalyst fines can also have a deleterious effect on catalyst performance. Furthermore, removal of catalyst fines can become an expensive and/or time-consuming step during the production process. Yet another disadvantage of heterogeneous catalysts is bypassing or channeling of the granular catalyst by the reactant mixture. When the reaction mixture bypasses the catalyst, the reaction may not proceed as efficiently, product yield may decrease, and product contamination may occur. Yet still another disadvantage associated with heterogeneous catalysts is compaction, which can result in unacceptable pressure drops that are unsuitable for the intended process. If the reactant mixture cannot pass through the catalyst chamber properly, a relatively large pressure drop may occur and a large amount of power, which may be in the form of additional applied pressure, will be required to push the reactant mixture through the chamber.

Accordingly, there is a need for new and improved devices heterogeneous catalysts that overcome the problems noted in the prior art. It would be advantageous if such catalyst devices eliminated or minimized release of catalyst fines, channeling or bypassing, and compaction.

### BRIEF SUMMARY

Disclosed herein is a process for producing an aqueous solution containing chlorine dioxide. The process generally includes flowing an aqueous solution of an acidified chlorite salt into a catalyst element, wherein the catalyst element comprises a porous aluminosilicate hydrogel-bonded ceramic composition defining a plurality of tortuous pathways and catalyst particles and/or catalytic sites disposed on surfaces defining the tortuous pathways; and contacting the acidified chlorite salt solution with the catalyst particles and/or catalytic sites to form chlorine dioxide in the aqueous solution

In another embodiment, the process includes flowing an alkali metal chlorite solution through an electrochemical acidification cell; exchanging the alkali metal with a proton to generate an effluent comprising an aqueous solution of acidified chlorite salt; flowing the aqueous solution of an acidified chlorite salt into a catalyst element, wherein the catalyst element comprises a porous aluminosilicate hydrogel-bonded ceramic composition defining a plurality of tortuous pathways and catalyst particles and/or catalytic sites disposed on surfaces defining the tortuous pathways; and contacting the aqueous solution of the acidified chlorite salt with the catalyst particles and/or catalytic sites to form chlorine dioxide in the aqueous solution.

A process for making a catalyst material includes admixing solutions of an aluminate, a silicate, porosity generating compounds, and a ceramic material; molding the admixture and forming an aluminosilicate hydrogel bonded porous ceramic structure having a defined porosity with a plurality of tortuous pathways; and contacting the surfaces of the tortuous pathways with a catalyst material; and heating the rigid porous ceramic structure to a temperature and time effective to activate the catalyst material so as to form the catalyst element.

### BRIEF DESCRIPTION OF THE DRAWINGS

Referring now to the figures, which are exemplary embodiments, and wherein the like elements are numbered alike:

FIG. 1 illustrates a schematic diagram of an apparatus for producing an aqueous solution of chlorine dioxide in accordance with one embodiment;

FIG. 2 illustrates a schematic diagram of an apparatus for producing an aqueous solution of chlorine dioxide in accordance with one embodiment; and

FIG. 3 illustrates a schematic diagram of an apparatus for producing an aqueous solution of chlorine dioxide in accordance with another embodiment.

### DETAILED DESCRIPTION

Disclosed herein is a process for producing an aqueous solution containing chlorine dioxide. The process generally includes contacting an acidified chlorite salt-based feedstream (which can include chlorous acid) with a catalyst material. Unlike the prior art, the catalyst material generally comprises a plurality of catalytic sites disposed within a rigid porous ceramic structure. The rigid porous ceramic structure provides a relatively large amount of surface area and because of the rigidity of the porous structure, allows the feedstream to flow relatively unimpeded as compared to granular systems, and is moldable into a variety of forms, for example. As such, a pressure drop through the ceramic structure, which is typically related to compaction, is relatively constant during processing and bypassing and/or channeling effects are virtually eliminated and/or significantly minimized.

The porous ceramic structure generally comprises a porous rigid body comprising a plurality of tortuous flow paths. Catalyst particles and/or sites, i.e., reactive species, are deposited onto the surfaces of the porous ceramic structure. Desirably, the reactive species are disposed onto the surfaces through chemisorption or physiosorption. The reactive species are desirably in fluid communication with the plurality of tortuous flow paths. Optionally, one or more of the plurality of catalyst particles or sites may further comprise a promoter and/or an ion exchange material, which may or may not be in fluid communication with the plurality of tortuous flow paths. In contrast to the prior art, the so formed heterogeneous catalyst material advantageously reduces desorption of reactive species from the rigid body and effectively eliminates release of catalyst fines. Furthermore, any bypassing or fluidizing of the catalyst material by a reactive mixture is effectively eliminated and any pressure drop that would typically occur through compaction is also eliminated and/or significantly reduced.

The term “catalyst particles and/or sites and/or reactive species” has its ordinary meaning as used herein, and generically describes a material which increases the rate of a chemical reaction but which is not consumed by the reaction. Further, the catalyst particles and/or sites affect only the rate of the reaction; it changes neither the thermodynamics of the reaction nor the equilibrium composition. Further, as used herein to describe the catalyst material or components of the catalyst material, the term “catalyst” is intended to refer to heterogeneous catalysts, as opposed to homogeneous or biological catalysts. The term “reactive species” is used herein for convenience to refer generically to an active component of the catalyst material during a chemical reaction process. The term “promoter” has its ordinary meaning as used herein and generally describes a material that is not catalytically active by itself but, when in the presence of the reactive species, enhances the performance of the reactive species. The term “support” has its ordinary meaning as used herein and generally describes an inactive component of the catalyst during the chemical reaction process. The terms “reaction mixture” or “reactant mixture” are used herein for convenience to refer generically to any reactants of a reaction that are brought into contact with the catalyst particles and/or sites. The term “ceramic” is given it ordinary meaning and generally refers to a high-temperature material used in forming substrates. This material can be inorganic, nonmetallic, and crystalline.

Also, as used herein, the terms “first,” “second,” and the like do not denote any order or importance, but rather are used to distinguish one element from another, and the terms “the” , “a” , and “an” do not denote a limitation of quantity, but rather denote the presence of at least one of the referenced item. Furthermore, all ranges disclosed herein are inclusive of the endpoints and independently combinable.

In one embodiment, the reactive species comprise a metal or metal oxide, wherein the metal comprises an element of Groups 3-10 and 14 of a Periodic Table of Elements. Preferably, the reactive species comprises a precious metal or precious metal oxide. Precious metals comprise the elements of Groups 8, 9, and 10 of the Periodic Table of Elements. In one exemplary embodiment, the reactive species is a platinum oxide.

In another embodiment, when the reactive species comprises a metal oxide, the metal of the metal oxide is desirably in its highest possible oxidation state. In another embodiment, for metals with multiple oxidation states, the metal of the metal oxide may be partially oxidized. For example, with platinum oxides, the platinum metal may be in the 2⁺ and/or in the 4⁺ oxidation state.

In yet another embodiment, the reactive species is in the form of fine powder particles. In another embodiment, the reactive species is in the form of coarse powder particles. Alternatively, the reactive species may be a mixture of fine and coarse powder particles. An average particle size of the reactive species is less than or equal to about 420 micrometers (40 U.S. mesh). More preferably, the average particle size of the reactive species is less than or equal to about 177 micrometers (80 U.S. mesh).

The porous ceramic structure includes numerous surfaces onto which the reactive species is adsorbed and may include any internal pore surface. The shape of the porous ceramic structure is not intended to be limited to any shape or dimension. For example, the porous ceramic structure can be dimensioned to fit within a cylindrical sleeve having a defined diameter and height. Likewise, the ceramic structure can be configured to have an inlet end and an outlet end, wherein external walls intermediate the inlet end and outlet end are sealed, i.e., the sealed walls being impermeable to a solution passing therethrough.

A suitable porous ceramic material may exhibit a wide range of chemical and structural properties. Exemplary ceramic materials based on clays include bentonite, smectite, montmorillonite, paligorskite, attapulgite, sepiolite, saponite, kaolinite, halloysite, hectorite, beidellite, stevensite, fire clay, ground shale, and the like. Examples of other classes of ceramics include earthy or inorganic materials such as silicon nitride, boron carbide, silicon carbide, magnesium diboride, ferrite, steatite, yttrium barium copper oxide, anthracite, glauconite, faujasite, mordenite, clinoptilolite, and the like. Carbon based ceramics include for example carbon black, activated carbon, carbon fibrils, carbon hybrids, and the like. Suitable oxides that are sometimes referred to as ceramics include for example oxides of titanium, aluminum, niobium, silicon, zinc, zirconium, cerium and the like. Examples of suitable mixed oxides include alumina-titania, alumina-zirconia, ceria-zirconia, ceria-alumina, silica-alumina, silica-titania, silica-zirconia, and the like. Suitable zeolites that an be referred to as ceramic include any of the more than about 40 known members of the zeolite group of minerals and their synthetic variants, including for example Zeolites A, X, Y, USY, ZSM-5, and the like, in varying Si to Al ratios. Suitable carbonates include for example carbonates of calcium, barium, strontium, and the like. Other ceramic materials will be apparent to those skilled in the art in view of this disclosure.

In one embodiment, the porous ceramic material is formed of a fired aluminosilicate hydrogel-bonded ceramic composition, which is capable of being molded into a desired configuration. For example, casting, injection molding, extrusion, and the like can configure the ceramic material into the desired shape as well as porosity. For example, the porous ceramic material may be cylindrical, rod-shaped, conical, frustoconical, disc-shaped, granular, pellet-shaped, spherical, or the like.

In a preferred embodiment, the porous ceramic structure comprises an aggregate bonded by an aluminosilicate hydrogel as described in U.S. Pat. Nos. 4,357,165, 4,432,798, 4,814,300, 4,871,495 4,878,947 and 4,976,760, all of which are incorporated herein by reference in their entireties. As described in those patents, the hydrogel results from the admixture of water soluble sources of both silicate and aluminate (typically, sodium silicate and sodium aluminate), which admixture then self-sets at ambient temperatures in times which can be exceedingly short (e.g., on the order of as little as a few seconds but typically on the order of a few minutes), but nevertheless can be controlled by predetermined choice of molar ratio between aluminate and silicate, concentration of water, and temperature. The ability to exercise control over setting times for the hydrogel binder leads to attainment of molded ceramic filters of both desired geometry and desired porosity. Also described in the above-noted patents is the utilization of the hydrogel components along with granular refractory particles to produce, e.g., molds, by virtue of the self-setting hydrogel serving to bind the granular materials into a self-supporting structure.

The mole ratios of aluminum oxide (Al₂O₃) to silicon dioxide (SiO₂) in the gel resulting from the admixture of solutions of sodium aluminate (xNa₂O.yAl₂O₃.nH₂O) and sodium silicate (xNa₂O.ySiO₂.nH₂O) can vary from about 0.45 to about 1.0. The optimum within this range will generally depend on considerations such as the amount of binder used, the type of silicate (e.g. sodium or potassium), the temperature and humidity conditions to which the raw sand as well as resulting mix is exposed, and the desired set time for the mold mix.

The admixed components for forming the aluminosilicate hydrogel can each have added to them and/or distributed between them additional components, which will make up the moldable ceramic composition. For example, the sodium aluminate and/or sodium silicate solutions can further include refractory ceramic materials such as those previously described above, particulate metal powders, a gel strengthening agent such as silica fume a surfactant component, and the like. The refractory ceramic materials generally will be present in the overall composition in a weight percentage of from about 50% to about 90%, preferably from about 60% to about 70%. Suitable refractory ceramic materials include, but are not limited to, cordierite, calcined kyanite and mixtures thereof. In one embodiment, the compositions containing nearly equal weight proportions of both cordierite and calcined kyanite, e.g., from about 30 to 35% of each ceramic.

The desired porosity in the final ceramic article can be provided as a consequence of in situ reaction between a metal powder and alkali compounds (e.g., sodium hydroxide) present in the moldable composition, resulting in development of hydrogen gas as a reaction by-product. As a consequence of this internal gas production and evolution, the composition will expand in volume in the mold (or during extrusion as the case may be) and develop porosity, the quantity of the composition obviously being regulated to take into account the expected (and predetermined) degree of expansion within the mold or during extrusion to arrive at the desired final density and size of the article. At the same time, the surfactant present in the composition can serve to break up the bubbles of evolving gas in the aqueous composition to achieve, controllably, suitably small bubbles and to assure that the porosity developed in the structure will be predominantly of the open-celled type, e.g., as required for filtration uses, or predominantly of the closed-cell type as useful, e.g., for applications where lower thermal conductivity, higher strength, buoyancy or the like is the ultimate criterion.

The porous ceramic material can be manufactured into various shapes such that it can fit snuggly inside a housing, such as a column. Several configurations of the porous ceramic material can be disposed within the housing column or alternatively, a single configuration of the porous ceramic material can be disposed within the housing.

An average pore volume of the porous ceramic structure is about 0.001 to about 5.0 cubic centimeters per gram (cm³/g). More preferably, the average pore volume of the support is about 0.01 to about 1 cm³/g. An average surface area of the support is about 1 to about 10,000 meters squared per gram (m²/g). More preferably, the average surface area of the support is about 100 to about 1500 m²/g. In those embodiments wherein multiple configurations are disposed within the housing, the porosity can be varied or static throughout the length of then housing as may be desired for different applications.

As previously disclosed, the porous ceramic structure further includes a plurality of catalytic particles and/or sites disposed on the surfaces that define the tortuous fluid pathways within the support. Optionally, one or more of the plurality of catalyst particles and/or sites comprises a promoter, wherein the promoter is a different material or composition than the reactive species. Suitable promoters include compositions comprising a Group 3-7 or 14 element or Rare Earth element of the Periodic Table of Elements, or a combination comprising at least one of the foregoing elements. Rare Earth elements include lanthanum, actinium, the Lanthanide series, and the Actinide series. Preferred promoters are Rare Earth oxides, including for example lanthanum, cerium, neodymium, and thorium oxides. In one embodiment, the promoter is in the form of fine powder particles. In another embodiment, the promoter is in the form of coarse powder particles. Alternatively, the promoter may be a mixture of fine and coarse powder particles. An average particle size of the promoter is less than or equal to about 420 micrometers (40 U.S. mesh). More preferably the average particle size of the promoter is less than or equal to about 177 micrometers (80 U.S. mesh). A molar ratio of the reactive species to the promoter is preferably about 0.3:1 to about 100:1. More preferably, the molar ratio of the reactive species to the promoter is about 10:1.

Optionally, one or more of the plurality of catalyst particles and/or sites comprises an ion exchange material (i.e., a natural or synthetic material that can undergo an ion exchange reaction), wherein the ion exchange material is different from the support. Ion exchange materials include, for example, ion exchange coals, mineral ion exchangers, synthetic inorganic ion exchangers, organic ion exchangers or the like, or a combination comprising at least one of the foregoing ion exchange materials. Suitable ion exchange coals include, for example, coals comprising weak acid moieties, such as a carboxylic acid functional group. Suitable mineral ion exchangers include, for example, ferrous aluminosilicates with cation exchange properties, (e.g., analcite, chabazite, glauconites, harmotome, heulandile, natrolite, montmorillonite, beidellite, and the like) or aluminosilicates with anion exchange properties (e.g., apatite, hydroxyapatite, monotmorillonite, kaolinite, feldspars, sodalites, cancrinites, and the like). Examples of suitable synthetic inorganic ion exchangers include microcrystals embedded in a porous clay binder, such as prepared by combining oxides of Groups 4 of the Periodic Table with oxides of Groups 5 and/or 6 and embedding them in the clay binder. Suitable organic ion exchangers include polyelectrolytes such as phenols, styrenes, or acrylates with cation exchange moieties (e.g., sulfonic acid group, carboxylic acid group, or the like) or anion exchange moieties (e.g., trimethylammonium group, dimethylethanolammonium group, or the like).

The reactive species, and/or the optional promoter, and/or the optional ion exchange material, may be disposed onto the surface of the porous ceramic structure by any of a number of techniques including for example impregnation, co-precipitation, deposition-precipitation, ion-exchange, dipping, spraying, vacuum deposition, adhesion, chemical bonding, or the like, or a combination comprising at least one of the foregoing disposing techniques.

The reactive species may be activated by heating the porous ceramic structure with the reactive species at about 100 to about 850 degrees Celsius (° C.). Activation of the reactive species may take from about 10 to about 240 minutes at the elevated temperature. Activation of the reactive species may be carried out, for example, in the presence of air, oxygen, water, hydrogen, or the like, or a combination comprising at least one of the foregoing.

In one exemplary embodiment the catalyst element as formed is cylindrical. The catalyst element is preferably capped at one open end, while the other open end is left uncapped. In one embodiment, the catalyst element is capped with a plugging material or may be pre-capped during fabrication. With a cylindrical catalyst element, the reaction mixture may flow through the tortuous paths in a radial direction from outside to inside allowing the entire exterior surface of the catalyst element to contact the reaction mixture. The uncapped end may provide an outlet for a catalyzed reaction mixture. Alternatively, the reaction mixture may flow through the tortuous paths from inside to outside, allowing the entire interior surface of the catalyst element to contact the reaction mixture. In this embodiment, the uncapped end provides an inlet for the reaction mixture. Dimensions such as length, inner diameter and outer diameter may readily be tailored toward the particular application. In one embodiment, the cylindrical catalyst element has a length of about 10 to about 75 centimeters (cm), an inner diameter of about 0.5 to about 20 cm, and an outer diameter of about 1 to about 25 cm. The tortuous paths may have any shape as determined by particle-particle interstices created within the catalyst element during its fabrication.

It should be recognized by those skilled in the art that the catalyst materials described herein may advantageously also function as filtering devices. In one embodiment, the catalyst material filters all or substantially all particulates of about 0.5 to about 100 micrometers. In another embodiment, the catalyst material filters all or substantially all particulates less than about 10 micrometers.

The catalyst materials described herein are further advantageous in that they may be used in numerous chemical reaction processes, including among others hydrogenation, dehydrogenation, hydrogenolysis, oxidation, reduction, alkylation, dealkylation, carbonylation, decarbonylation, coupling, isomerization, amination, deamination, hydrodehalogenation, or the like.

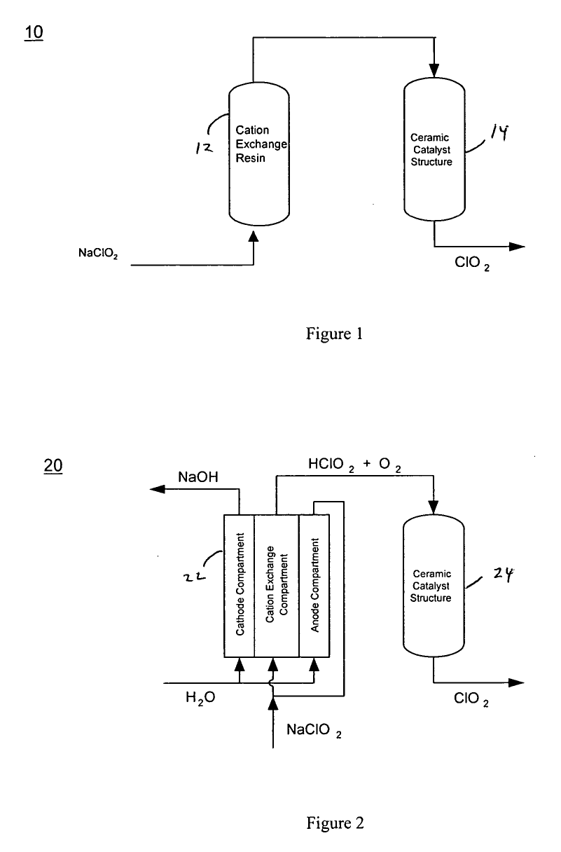

A preferred process of use is the oxidative production of a halogen oxide from an alkali metal halite solution such as chlorine dioxide form an alkali metal chlorite salt solution. As is generally shown in FIG. 1, one such process 10 generally comprises employing a cation exchange column 12 for producing an aqueous effluent containing halous acid from the alkali metal halite solution, which is then fed to a catalytic reactor containing the catalyst element for converting the halous acid to halogen oxide. The contacting the alkali metal chlorite solution with the cation exchange generates the halous acid. Alternatively. The alkali metal chlorite salt solution can be acidified with a protic acid, e.g., HCl, H₂SO₄, and the like.

As is generally shown in FIG. 2, a second such process 20 comprises employing an electrochemical acidification cell 22 for producing an aqueous effluent containing a halous acid from the alkali metal halite solution, which is then fed to a catalytic reactor 24 containing the catalyst material for converting the halous acid to halogen oxide. Suitable electrochemical cells are disclosed in U.S. Pat. No. 6,913,741 incorporated herein by reference in its entirety.

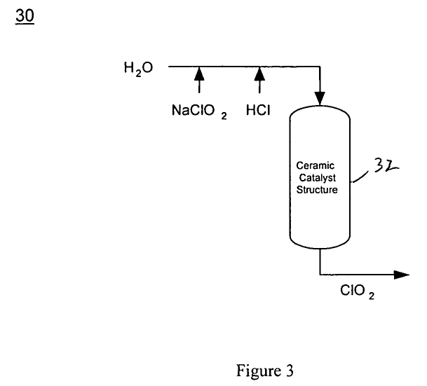

As is generally shown in FIG. 3, a third such process 30 generally comprises mixing an alkali metal halite solution and a mineral acid to form an acidified chlorite salt solution, which is then fed to a catalytic reactor 32 containing the catalyst element for converting the halous acid to halogen oxide. In one exemplary embodiment, the catalyst material is used in the production of chlorine dioxide from an alkali metal chlorite solution. In the case of the acid, either an inorganic or organic acid can be employed. The selected acid preferably has an acid dissociation constant expressed in the form of pKa, of less than 4.0 and is in an amount effective to lower the pH to about 2.0 to about 3.0. Examples of suitable acids include, but are not limited to, hydrochloric, sulfuric, phosphoric, amidosulfonic, bromoacetic, chloroacetic, citric, maleic, malic, oxalic, sodium acid sulfate, succinic acids, or mixtures thereof.

Optionally, an oxidizer such as those materials that emit oxygen or other oxidizing materials, such as ozone or chlorine, is added to the solution in an amount that corresponds to the concentration of the water-soluble chlorite and stoichiometry of the desired chlorine dioxide reaction. Examples of such oxidizers include, but are not intended to be limited to, sodium hypochlorite, chlorine gas, sodium perborate, strontium peroxide, sodium or potassium peroxydisulfate, sodium peroxide, trichloroisocyanuric acid, calcium hypochlorite, 1,3-dichloro-5,5-diemthylhydantoin, 1,3-dibromo-5,5-dimethylhydrantoin, 1-chloro-30

### EXAMPLES

All of the experiments were conducted with the following parameters recorded; chlorine dioxide flow rate, concentration, pH, and temperature and sodium chlorite and acid flow rates.

Method 8138 (HACH Company) was used for the measurement of chorine dioxide. For calibration, a pure chlorine dioxide solution was prepared and titrated according to lodometric Method 4500-ClO₂ in Standard Methods for the Examinations of Water and Wastewater 20^{th} edition 1998. Before the spectrophotometer was calibrated for ClO₂ readings, the UV lamp was replaced and the wavelength calibrated according to manufacturer's instructions for calibrating the wavelength on 2010 series meters. Using the pure chlorine dioxide solution obtained from method 4500-ClO₂, the spectrophotometer was then given a calibration factor where it deviated from the titrated ClO₂ concentration.

Measurement of yield efficiency provides a standard for evaluating actual performance of the catalyst-filled cartridge. Yield is defined as the actual amount of reactant transformed or converted. Actual yield in a reaction is ordinary less than the theoretical yield. The yield efficiency is expressed as a percentage and is defined as:

$$\% Yield = \frac{actual yield}{theoretical yield} \times 100$$

The actual yield is determined from amount of chlorine dioxide that is actually generated. The theoretical yield is calculated by the amount of the chlorine dioxide that could possibly be obtained from the concentration of sodium chlorite in the feed solution.

All of the experiments were only conducted to demonstrate the process of using a Bioblox catalyst structure for chlorine dioxide production. Optimizing the process is expected to provide increased yields.

### Example 1

In this Example, four pieces of the catalyst material as described herein, measuring approximately 1.3″ in outside diameter and 4″ in length, were snuggly fit into a 24″ column, whose inner diameter was approximately 1.0″. The porosity of the ceramic structure was characterized as medium, which consisted of approximately 70% porosity. To place the platinum on the surface of the porous ceramic structure and form the catalyst material, an 87 mL precursor solution was made by dissolving 1.24 grams of tetraammineplatinum (II) chloride crystal into 2.6 mL of 30% ammonia hydroxide and 52.2 mL of 60% isopropyl alcohol at 35° C., such that the solution contained 0.69 grams of platinum. The porous ceramic structure was submerged in the precursor solution for three hours so as to wet the entire internal and external surfaces of the structure. The wetted structure was dried, placed in a ceramic crucible, and calcined under an oxygen-containing environment at 450° C. for 60 minutes. The quantity of platinum on the porous ceramic structure was determined to be approximately 0.22% by weight.

The flow rate through the column was controlled by a needle valve. Two peristaltic pumps were used to inject a 25% sodium chlorite (NaClO₂) and 22% N hydrochloric acid (HCl) solutions and mix prior to the injection into the column as generally shown in FIG. 3.

Table 1 displays the results of the experiment. The column containing the catalyst material was operated for two hours.

TABLE 1
Performance of the Ceramic Catalyst Structure for ClO₂ Production

| | |
|---|---|
| ClO₂ Flow Rate, mL/min | 220 |
| NaClO₂ Flow Rate, mL/min | 0.49 |
| HCl Flow Rate, mL/min | 0.46 |
| ClO₂ Concentration, ppm | 363 |
| ClO₂ pH | 2.68 |
| ClO₂ Temperature, ° C. | 18.1 |
| Yield, % | 90.3 |

The acid-chlorite reaction system in this example utilized the following stoichiometry in accordance with the following scheme (I):
5 NaClO₂+4 HCl→4 ClO₂+5 NaCl+2 H₂O (I)

The yield was calculated by following mathematical relationship:

$$\% Yield = \frac{{[ {ClO}_{2} ]}_{product}}{( 4 / 5 ) * {[ {NaClO}_{2} ]}_{feed}} \times 100$$

### Example 2

In this Example, four pieces of the catalyst material as in Example 1 measuring approximately 1.0″ in outside diameter and 4″ in length were snuggly fit into a 24″ column, whose inner diameter was approximately 1.0″. The porosity was characterized as medium, consisting of approximately 70% porosity.

As generally shown in FIG. 2, an electrochemical acidification cell was first used to convert the sodium chlorite to chlorous acid. The acidification cell composed of three chambers and two cation-permeable membranes. The central chamber contained a bed of highly crosslinked macro-porous cation exchange resin. One end chamber contained a cathode and the other an anode. Both end chambers were also filled with cation exchange resin. A transverse DC electric field was imposed by an external power supply via the electrodes.

The width and length of all three chambers were 5.08 cm and 25.4 cm, respectively. The thickness of the center chamber and both end chambers were 1.27 cm and 0.64 cm, respectively.

Softened water was passed upwardly through the anode compartment at a flow rate of about 175 mL/min at 30° C. A 25-wt % of sodium chlorite solution was added to the effluent of the anode compartment such that the final concentration of sodium chlorite was about 1,000 mg/L. The sodium chlorite solution was then passed through the center compartment from bottom to top. Softened water was passed upwardly through the cathode compartment at a flow rate of about 50 mL/min. While passing the solutions through the compartments of the reactor, a controlled current of about 4.5 A was applied to the anode and cathode. The effluent from the center compartment was finally passed through the column containing the catalyst material from top to bottom.

Table 2 displays the results of the experiment. The system was operated for two hours.

TABLE 2
Performance of the Catalyst Material for ClO₂ Production

| | |
|---|---|
| ClO₂ Flow Rate, mL/min | 252 |
| NaClO₂ Flow Rate, mL/min | 0.49 |
| ClO₂ Concentration, ppm | 324 |
| ClO₂ pH | 2.75 |
| ClO₂ Temperature, ° C. | 20.7 |
| Yield, % | 92.5 |

The reaction system in this example utilized the chlorous acid decomposition stoichiometry as shown scheme (II) below, wherein five moles of HClO₂ was required to make four moles of ClO₂:
5 HClO₂→4 ClO₂+HCl+2 H₂O (II)

The yield was calculated in accordance with the following mathematical relationship.

$$\% Yield = \frac{{[ {ClO}_{2} ]}_{product}}{( 4 / 5 ) * {[ {HClO}_{2} ]}_{feed}} \times 100$$

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A process for producing chlorine dioxide comprising:
flowing an aqueous solution of an acidified chlorite salt into a catalyst element, wherein the catalyst element comprises a porous aluminosilicate hydrogel-bonded ceramic composition defining a plurality of tortuous pathways and catalyst particles and/or catalytic sites disposed on surfaces defining the tortuous pathways; and
contacting the acidified chlorite salt solution with the catalyst particles and/or catalytic sites to form chlorine dioxide in the aqueous solution.

2. The process according to claim 1, wherein flowing the acidified chlorite solution into the catalyst element first comprises contacting an alkali metal chlorite solution with a cation exchange material in a hydrogen form to form the acidified chlorite salt solution.

3. The process according to claim 1, wherein flowing the acidified chlorite solution into the catalyst element first comprises contacting an alkali metal chlorite solution with an acid to form the acidified chlorite salt solution.

4. The process according to claim 1, wherein flowing the acidified chlorite solution into the catalyst element first comprises feeding an alkali metal chlorite solution to an acidification cell to form the acidified chlorite solution.

5. The process according to claim 1, wherein a pH of the acidified chlorite salt solution is about 2 to about 3.

6. The process according to claim 1, wherein the acidified chlorous salt comprises chlorous acid.

7. The process according to claim 1, wherein the porous aluminosilicate hydrogel-bonded ceramic composition comprises a refractory ceramic material, a particulate metal powder, a gel strengthening agent, a surfactant, or a combination comprising at least one of the foregoing.

8. The process according to claim 7, wherein the refractory ceramic material comprises about 50 to about 90 weight percent of the porous ceramic support.

9. The process according to claim 7, wherein the refractory ceramic material comprises cordierite, calcined kyanite, or a combination comprising at least one of the foregoing.

10. The process according to claim 1, wherein the catalyst element has a cylindrical shape having an open end, a plugged end, and impermeable walls extending between the open end and the plugged end.

11. A process for producing chlorine dioxide comprising:
flowing an alkali metal chlorite solution through an electrochemical acidification cell;
exchanging the alkali metal with a proton to generate an effluent comprising an aqueous solution of acidified chlorite salt;
flowing the aqueous solution of an acidified chlorite salt into a catalyst element, wherein the catalyst element comprises a porous aluminosilicate hydrogel-bonded ceramic composition defining a plurality of tortuous pathways and catalyst particles and/or catalytic sites disposed on surfaces defining the tortuous pathways; and
contacting the aqueous solution of the acidified chlorite salt with the catalyst particles and/or catalytic sites to form chlorine dioxide in the aqueous solution.

12. The process according to claim 11, wherein a pH of the acidified chlorite salt is about 2 to about 3.

13. The process according to claim 11, wherein the acidified chlorous salt comprises chlorous acid.

14. A process for making a catalyst element, the process comprising:
admixing solutions of an aluminate, a silicate, porosity generating compounds, and a ceramic material;
molding the admixture and forming an aluminosilicate hydrogel bonded porous ceramic structure having a defined porosity with a plurality of tortuous pathways; and
contacting the surfaces of the tortuous pathways with a catalyst material; and heating the porous aluminosilicate hydrogel-bonded ceramic structure at a temperature and time effective to activate the catalyst material so as to form the catalyst element.

15. The process of claim 14, wherein the aluminate to the silicate is at a molar ratio of about 0.45 to about 1.0.

16. The process of claim 14, wherein the ceramic material is at weight percentage of 50% to 90% based on an overall weight of the rigid porous ceramic structure.

17. The process of claim 14, wherein the porosity generating compounds comprise a metal compound and alkali, wherein the metal compound and the alkali react to form a hydrogen gas.

18. The process of claim 14, wherein the porous aluminosilicate hydrogel-bonded ceramic structure has an average pore volume of 0.001 to 5.0 cubic centimeters per gram.

19. The process of claim 14, wherein the catalyst material comprises a metal or an oxide of the metal, wherein the metal comprises an element of Groups 3-10 and 14 of a Periodic Table of Elements.
